(19) United States
(12) Patent Application Publication
(10) Pub. No.: US 2011/0232997 A1
(43) Pub. Date: Sep. 29, 2011

(54) DESCENDING LIFE LINE FOR EMERGENCY ESCAPE

(76) Inventor: Jong Mun Wang, Gwangyang-si (KR)

(21) Appl. No.: 12/671,911

(22) PCT Filed: Jul. 23, 2008
(86) PCT No.: PCT/KR08/04313

§ 371 Date: Feb. 2, 2010

(30) Foreign Application Priority Data
Aug. 2, 2007 (KR) 10-2007-0077651

(51) Int. Cl. A62B 1/10; A62B 1/06

(52) U.S. Cl. 182/133

(57) ABSTRACT

Disclosed is an escape descender for emergency escape movably installed to an escape line. The escape descender includes a case defining a vertical rope passage therein, a roller support having a lateral opening facing the rope passage and adapted to move close to or away from the rope passage, a rotatable holding lever to cause the opening of the roller support to be close to or away from the rope passage, movable rollers arranged in the roller support so as to partially protrude from the opening, stationary rollers arranged in the case such that an outer periphery of each stationary roller opposes an outer periphery of the corresponding movable roller. One of the stationary rollers is rotatably supported on a drum of the case and incorporates a brake lever provided with a pad, the brake lever being centrifugally rotated to cause the pad to come into contact with the drum.

### TECHNICAL FIELD

The present invention relates to an escape descender for emergency escape, and more particularly, to an escape descender for emergency escape, which can be movably installed, at a desired safe position, to an escape line hanging from a building rather than being mounted to a fixed position of the building, thereby enabling safe descent via the escape line.

### BACKGROUND ART

Generally, an escape descender for emergency escape is a device enabling persons to rapidly escape from a multistory building upon occurrence of accidents such as fires, etc.

Considering one exemplary conventional escape descender for emergency escape, upon occurrence of fires or other emergency situations, a user fastens a body of the escape descender to a loop that is previously mounted to an inner wall of a building at an upper end position of a window, and wears a waist belt provided at an end of a wire rolled within the body. Then, if the user leaps out of the window and hangs in the air, the user can descend as the escape line rolled in the body is unrolled by the user's weight, thereby escaping from danger.

However, the above-described conventional escape descender for emergency escape is available only at places where the loop is previously mounted and therefore, cannot be used if there exists no loop or a loop mounting location is already exposed to danger. Moreover, since most buildings are not provided with the escape descender for management costs reasons, the conventional escape descender for emergency escape has serious problems in availability and management.

### DISCLOSURE OF INVENTION

### Technical Problem

Therefore, the present invention has been made in view of the above problems, and it is an object of the present invention to provide an escape descender for emergency escape, which can be movably installed, at a desired safe position, to an escape line hanging from a building rather than being mounted to a fixed position of the building, thereby enabling safe descent via the escape line.

### Technical Solution

In accordance with the present invention, the above and other objects can be accomplished by the provision of an escape descender for emergency escape comprising: a case externally provided with a handle to be gripped by hand or a connector to be connected to a person, and internally defining a rope passage vertically penetrated through the case; a roller support reciprocally movably mounted in the case while being supported by a guide formed at the case and formed throughout a lateral side thereof with an elongated opening, the roller support being reciprocally moved close to or away from the rope passage defined in the case in a state in which the opening faces the rope passage; a holding lever reciprocally rotatably mounted in the case and adapted to move the roller support in a direction causing the opening of the roller support to be close to or away from the rope passage of the case when the holding lever is rotated counterclockwise or clockwise; a plurality of movable rollers vertically arranged in a line within the roller support and rotatably coupled to the roller support so as to partially protrude outward from the opening of the roller support; and a plurality of stationary rollers vertically arranged in a line within the case and rotatably coupled to the case such that an outer periphery of each stationary roller opposes an outer periphery of the corresponding movable roller in the rope passage of the case, at least one of the stationary rollers being rotatably supported on a drum formed at the case and containing a brake lever provided with a pad, the brake lever being rotated by a centrifugal force in a direction causing the pad to come into contact with the drum.

The escape descender may further comprise an emergency brake unit, and the emergency brake unit may include: a brake member to be moved close to or away from an outer periphery of one of the stationary rollers; a spring to apply an elastic force to the brake member in a direction causing the brake member to come into close contact with the outer periphery of the stationary roller; a link to move the brake member in a direction causing the brake member to come into close contact with the outer periphery of the stationary roller; and a connector band having one end connected to the link and the other end connected to a person, the connector band rotating the link, upon receiving an external pulling force, in a direction causing the brake member to come into close contact with the outer periphery of the stationary roller.

### Advantageous Effects

With the above-described configuration, an escape descender for emergency escape according to the present invention can be movably installed, at a desired safe position, to an escape line hanging from a building, rather than being mounted to a fixed position of the building. Accordingly, the escape descender of the present invention advantageously enables safe descent via the escape line.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a sectional view illustrating an escape descender for emergency escape according to an embodiment of the present invention;

FIG. 2 is an exploded perspective view illustrating the internal configuration of the escape descender for emergency escape according to the embodiment of the present invention; and

FIGS. 3 and 4 are sectional views illustrating a stationary roller provided in the escape descender for emergency escape according to the embodiment of the present invention.

### BEST MODE FOR CARRYING OUT THE INVENTION

Hereinafter, an escape descender for emergency escape according to an embodiment of the present invention will be described in more detail with reference to the accompanying drawings.

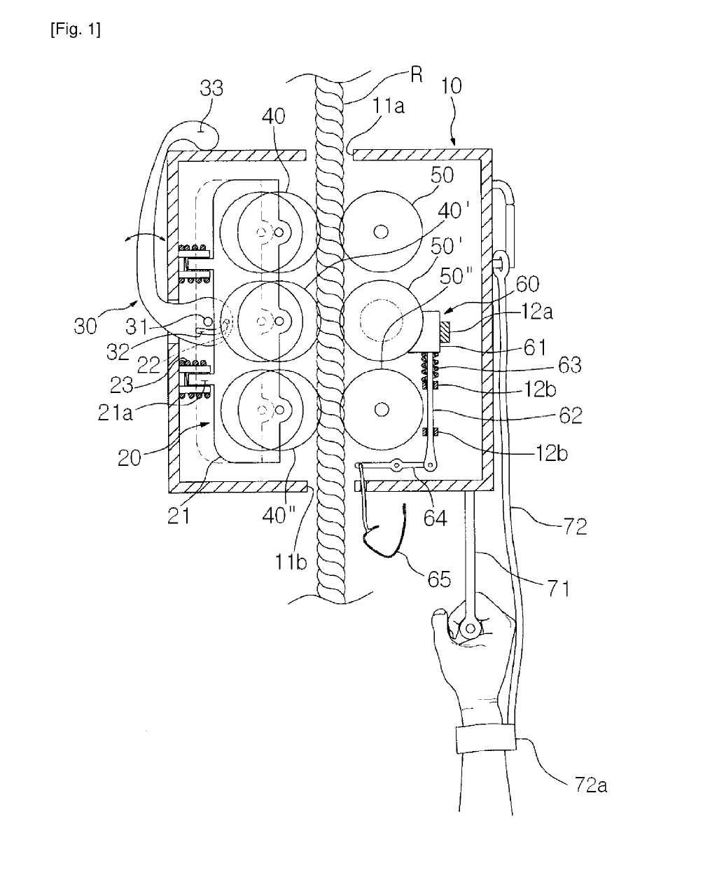

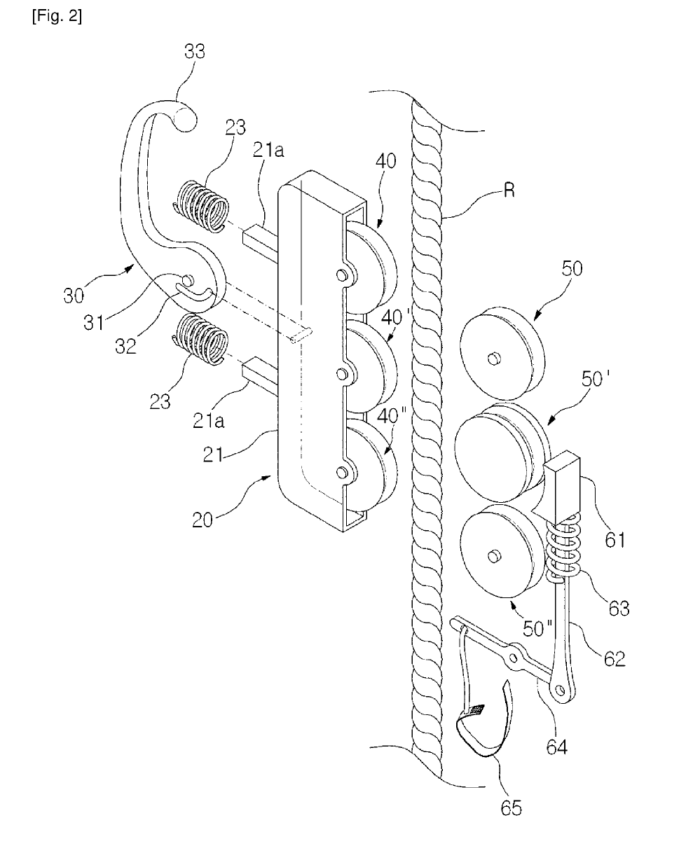

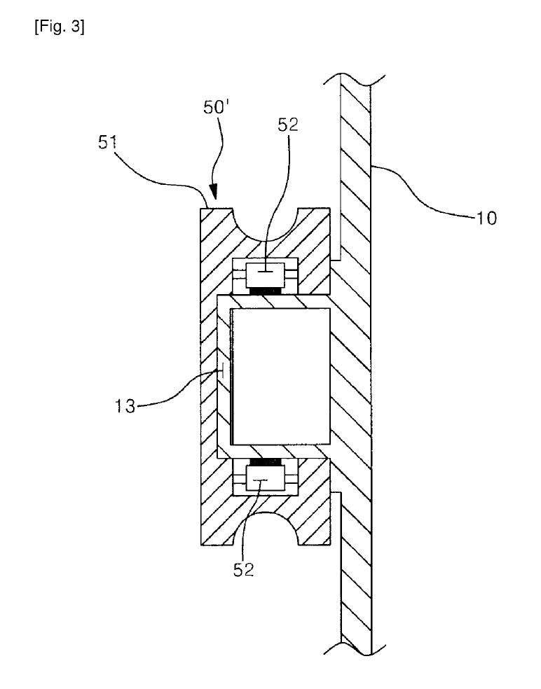

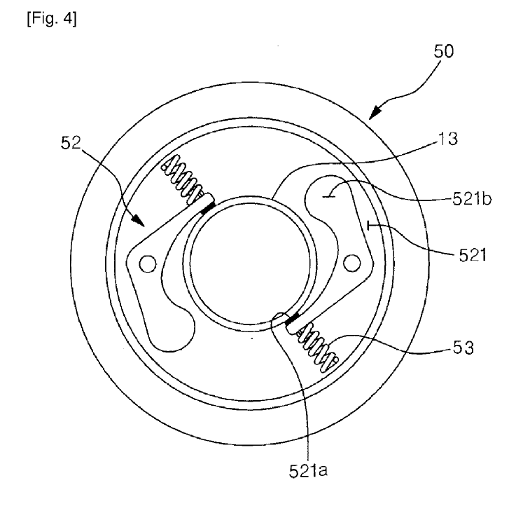

FIG. 1 is a sectional view illustrating an escape descender for emergency escape according to an embodiment of the present invention, and FIG. 2 is an exploded perspective view illustrating the internal configuration of the escape descender for emergency escape according to the embodiment of the present invention. Also, FIGS. 3 and 4 are sectional views illustrating a stationary roller provided in the escape descender for emergency escape according to the embodiment of the present invention.

The present invention is devised to be installed to an escape rope R hanging from a multistory building, such as an apartment complex, to reduce a descending speed of a person who is climbing down the rope R. Referring to the drawings, the escape descender for emergency escape according to the embodiment of the present invention includes a case 10, a roller support 20, a holding lever 30, movable rollers 40, 40′ and 40″, stationary rollers 50, 50′ and 50″, an emergency brake unit 60, a handle 71, and a safety rope 72.

The case 10 is externally provided with the handle 71 to allow a person to grip the handle 71 with his/her hand, or a connector to which a person will be connected, and is configured to receive various constituent elements including, for example, the roller support 20 therein. The case 10 has rope passage holes 11a and 11b perforated through centers of top and bottom walls thereof, to allow the rope R to vertically penetrate through the case 10. On the basis of a resulting rope passage along which the rope R vertically penetrates through the case 10, the interior of the case 10 is divided into two sections, and one of the two sections is formed with a guide to support the roller support 20.

The roller support 20 is mounted therein with the movable rollers 40, 40′ and 40″, and serves to move the movable rollers 40, 40′ and 40″ in a direction causing the movable rollers 40, 40′ and 40″ to be brought into close contact with or be spaced apart from the rope R. Referring to the drawings, the roller support 20 includes a body 21 formed, throughout one lateral side thereof, with an elongated opening to expose the respective movable rollers 40, 40′ and 40″ partially. In a state wherein the opening of the body 21 faces the rope passage of the case 10, the body 21 of the roller support 20 is reciprocally movable in a direction causing the opening to be close to or away from the rope passage. The body 21 of the roller support 20 is further formed with guide protrusions 21a at an opposite lateral side of the opening. The roller support 20 is mounted into the case 10 such that the guide protrusions 21a are inserted into and supported by the guide formed in the case 10. Also, the roller support 20 is elastically supported by compressive springs 23 inserted between the guide protrusions 21a and the guide of the case 10. With elasticity of the compressive springs 23, the roller support 20 is pushed in a direction causing the movable rollers 40, 40′ and 40″, mounted in the roller support 20, to be brought into close contact with the rope R. The elastically supported roller support 20 retreats from the rope R, via operation of a cam, in a direction causing the movable rollers 40, 40′ and 40″ to be spaced apart from the rope R if the holding lever 30 is manually rotated clockwise. Once the movable rollers 40, 40′ and 40″ retreat, the rope R is freely movable in the rope passage of the case 10 between the movable rollers 40, 40′ and 40 and the stationary rollers 50, 50′ and 50″. Then, if the holding lever 30 is manually rotated counterclockwise, the movable rollers 40, 40′ and 40″ of the roller support 20 advance close to the rope R via operation of a cam, thereby allowing the rope R to be tightly caught between the movable rollers 40, 40′ and 40″ and the stationary rollers 50, 50′ and 50″.

The holding lever 30 is mounted, in a reciprocally pivotable manner, to a pivot shaft 31 provided at the case 10. When the holding lever 30 is pivotally rotated counter-clockwise, the holding lever 30 presses the roller support 20 in a direction causing the movable rollers 40, 40′ and 40″, partially exposed from the opening of the roller support 20, to be brought into close contact with the rope R located in the rope passage of the case 10. On the other hand, when the holding lever 30 is pivotally rotated clockwise, the roller support 20 is moved in a direction causing the moving rollers 40, 40′ and 40″ to be spaced apart from the rope R located in the rope passage of the case 10. Referring to the drawings, the holding lever 30 is formed with a cam slot 32, and the roller support 20 is formed with a cam pin 22 to be inserted into the cam slot 32 of the holding lever 30, for connection of the holding lever 30 and the roller support 20. Thereby, as the holding lever 30 connected to the roller support 20 is pivotally rotated clockwise or counterclockwise, the cam pin 22 of the roller support 20 moves along the cam slot 32 of the holding lever 30, allowing the roller support 20 to be reciprocally moved close to or away from the rope R.

The plurality of movable rollers 40, 40′ and 40″ are vertically arranged in a line within the body 21 of the roller support 20. The movable rollers 40, 40′ and 40″ are rotatably coupled to the body 21 of the roller support 20 such that the respective movable rollers 40, 40′ and 40″ partially protrude outward from the opening of the body 21.

The stationary rollers 50, 50′ and 50″ are arranged opposite to the respective movable rollers 40, 40′ and 40″ such that the rope R passing the rope passage of the case 10 is caught between the stationary rollers 50, 50′ and 50″ and the movable rollers 40, 40′ and 40″. Referring to the drawings, the stationary rollers 50, 50′ and 50″ are vertically arranged in a line within the case 10 and are rotatably coupled to the case 10 such that an outer periphery of each stationary roller opposes an outer periphery of the corresponding movable roller in the rope passage of the case 10. Of the plurality of stationary rollers 50, 50′ and 50″, the middle stationary roller 50′ is provided with a brake system to reduce a descending speed of the rope R. Referring to the drawings, the case 10 incorporates a drum 13 to rotatably support the middle stationary roller 50′. Specifically, the middle stationary roller 50′ is rotatably supported on the drum 13 and is provided with a brake unit 52 to reduce a descending speed of the rope R using a frictional force. Referring to the drawings, the brake unit 52 includes a pair of brake levers 521, each of which is provided at an inner periphery thereof with a pad 521a. The brake lever 521 is rotated by a centrifugal force in a direction causing the pad 521a to come into contact with the drum 13. For this, the brake lever 521 has a centrifugal mass portion 521b to receive a centrifugal force, and the centrifugal mass portion 521b is formed at an opposite side of the pad 521a on the basis of a rotation center of the brake lever 521. Also, to apply an elastic force to the brake lever 521 for rotating the brake lever 521 in a direction causing the pad 521a to come into close contact with the drum 13, the brake lever 521 is provided with a spring 53 in such a manner that one end of a spring 53 is connected to the case 10 and the other end of the spring 53 is connected to the brake lever 521.

The emergency brake unit 60 serves to increase a frictional force between the rope R and the rollers, in order to further reduce a descending speed of the rope R under an emergency situation. Referring to the drawings, the emergency brake unit 60 includes a brake member 61, a connecting link 62, a spring 63, a link 64, and a connector band 65. The brake member 61 is supported on a holder 12a formed at the case 10 and is moved close to or away from an outer periphery 51 of the middle stationary roller 50′. The connecting link 62 extends downward from a lower end of the brake member 61 and is supported on a guide supporting portion 12b formed at the case 10. The connecting link 62 is reciprocally moved together with the brake member 61, to guide reciprocating movements of the brake member 61. The spring 63 has one end connected to the case 10 and the other end connected to the brake member 61, and serves to apply an elastic force to the brake member 61 in a direction causing the brake member 61 to come into close contact with the outer periphery 51 of the middle stationary roller 50′. The link 64 is connected at one end thereof to a lower end of the connecting link 62 while being rotatably supported in the case 10, and serves to move the brake member 61 in a direction causing the brake member 61 to come into close contact with the outer periphery 51 of the middle stationary roller 50′. The connector band 65 has one end connected to the link 64 and the other end connected to a person. When the connector band 65 is pulled by an external force, the connector band 65 rotates the link 64, causing the brake member 61 to come into close contact with the outer periphery 51 of the middle stationary roller 50′.

Meanwhile, to safely maintain connection between a person and the case 10 even if the user misses the handle 71 provided at the external surface of the case 10, the safety rope 72 is connected to the case 10. The safety rope 72 is provided at one end thereof with a wrist band 72a, so as to be connected to the user's wrist.

### INDUSTRIAL APPLICABILITY

As apparent from the above description, the present invention provides an escape descender for emergency escape, which can be movably installed, at a desired safe position, to an escape line hanging from a building rather than being mounted to a fixed position of the building. With this configuration, the escape descender of the present invention advantageously enables safe descent via the escape line.

1. An escape descender for emergency escape comprising:
a case externally provided with a handle to be gripped by hand or a connector to be connected to a person, and internally defining a rope passage vertically penetrated through the case;
a roller support reciprocally movably mounted in the case while being supported by a guide formed at the case and formed throughout a lateral side thereof with an elongated opening, the roller support being reciprocally moved close to or away from the rope passage defined in the case in a state in which the opening faces the rope passage;
a holding lever reciprocally rotatably mounted in the case and adapted to move the roller support in a direction causing the opening of the roller support to be close to or away from the rope passage of the case when the holding lever is rotated counterclockwise or clockwise;
a plurality of movable rollers vertically arranged in a line within the roller support and rotatably coupled to the roller support so as to partially protrude outward from the opening of the roller support; and
a plurality of stationary rollers vertically arranged in a line within the case and rotatably coupled to the case such that an outer periphery of each stationary roller opposes an outer periphery of the corresponding movable roller in the rope passage of the case, at least one of the stationary rollers being rotatably supported on a drum formed at the case and containing a brake lever provided with a pad, the brake lever being rotated by a centrifugal force in a direction causing the pad to come into contact with the drum.

2. The escape descender according to claim 1, further comprising an emergency brake unit,
wherein the emergency brake unit includes:
a brake member to be moved close to or away from an outer periphery of one of the stationary rollers;
a spring to apply an elastic force to the brake member in a direction causing the brake member to come into close contact with the outer periphery of the stationary roller;
a link to move the brake member in a direction causing the brake member to come into close contact with the outer periphery of the stationary roller; and
a connector band having one end connected to the link and the other end connected to a person, the connector band rotating the link, upon receiving an external pulling force, in a direction causing the brake member to come into close contact with the outer periphery of the stationary roller.
